(19) United States
(12) Patent Application Publication
(10) Pub. No.: US 2013/0204804 A1
(43) Pub. Date: Aug. 8, 2013

(54) SYSTEMS AND METHODS FOR CALCULATING VALUE OF A STOCK

(71) Applicant: Open Financial Analytics Pte Ltd, Singapore (SG)

(72) Inventor: Chee We Ng, Shanghai (CN)

(73) Assignee: Open Financial Analytics Pte Ltd, Singapore (SG)

(21) Appl. No.: 13/746,662

(22) Filed: Jan. 22, 2013

Related U.S. Application Data
(60) Provisional application No. 61/594,526, filed on Feb. 3, 2012.

(51) Int. Cl. G06Q 40/06

(52) U.S. Cl. CPC G06Q 40/06
USPC 705/36 R

(57) ABSTRACT

A system for analyzing a security includes a processor; an input module configured to cause a graphical user interface to be rendered on a user's client device, the interface including a screen presenting a predetermined limited number of inputs relating to characteristics affecting valuation of a security, the predetermined number being not more than four; a forecast valuation module configured to compute, using the processor acting on the inputs, fair price and expected return for the security; and an output module configured to cause the user's client device to display fair price and expected return for the security. Other systems and methods, and computer readable media are disclosed.

### CROSS REFERENCE TO RELATED APPLICATION

This application claims 35 U.S.C. 119(e) priority to co-pending U.S. Provisional Application 61/594,526, filed Feb. 3, 2012, invented by the inventor of this invention, titled “SYSTEMS AND METHODS FOR CALCULATING FAIR VALUE OF A STOCK,” and incorporated herein by reference.

### TECHNICAL FIELD

The technical field comprises graphical user interfaces. The technical field also comprises technical analysis of securities. The technical field also comprises creation and dissemination of analysis of financial markets.

### BACKGROUND

Traditionally, analyses of stock prices going forward are performed on computer spreadsheets, which include both offline versions such as Microsoft Excel and Open Office and online versions such as Google Docs and EditGrid. They typically require input into cells in a spreadsheet table. Traditional methods of analyzing stock prices going forward focus on discounted cash flows (DCF), and seldom do they compute the expected return of the stock.

### SUMMARY

Some embodiments provide a system for analysis of stock or security prices going forward. In some embodiments, the system provides a user the ability to calculate the fair price of a stock or security, as well as the expected investment return by investing in this stock or security. Unlike many solutions, the system calculates these two answers with no more than three inputs, while providing the decomposition of the fair price and expected return into its key economic drivers. This helps an ordinary person, who doesn't want to be bogged with all the details, to do a quick calculation and understand the key drivers of the results. In this way, as compared to the traditional way, the user can then focus on the main drivers instead of wasting time figuring out the inputs.

Some embodiments provide a system that computes the breakdown of return into components. Decomposition of fair value into earnings growth horizons is much more informative than the traditional discounted cash flow.

In some embodiments, the system calculates expected return and does not require cost of equity as an input, which is often a source of uncertainty on its own. In some embodiments, the system allows a user to analyze if investing in a stock or security will achieve a certain investment return hurdle rate, which analyzing the fair value does not allow.

Some embodiments provide a system that illustrates the relationships between value of a stock or security and key drivers. A user can understand what the forward-looking inputs or assumptions need to be in order for the fair value to be at the current market price. This helps the user focus on the specific analysis that is needed.

Some embodiments provide a system that illustrates the relationships between investment return in a stock and key drivers. A user can understand what the forward-looking inputs or assumptions need to be in order for the investment return to reach a certain level. This helps the user focus on the specific analysis that is needed.

In some embodiments, the system is interactive and easy to use.

In some embodiments the system has one or more of the following features:

(i) A user can easily calculate fair value of the stock or security, future expected return, and their decomposition by entering three predetermined inputs using sliders;

(ii) The fair value of the stock or security is decomposed graphically into one or more of:
a. Value of zero growth earnings,
b. Value of short-term earnings growth,
c. Value of long-term earnings growth;

(iii) Future expected return is decomposed graphically into:
a. Return from zero growth earnings,
b. Capital needs needed for short-term earnings growth,
c. Short-term earnings growth,
d. Return from change in Price-Earnings ratio; and

(iv) The system automatically re-calculates the answers when inputs are changed, and renders a set of charts that enable a user to understand the analysis.

Some embodiments provide various methods corresponding to the various systems described.

Various combinations of these features are possible.

In contrast, previous solutions are generally implemented in spreadsheets and typically have one or more of the following disadvantages:

(i) There are many inputs for the user to enter;

(ii) Decomposition of value into free cash flow horizons is not as informative as decomposition of value into earnings and earnings growth from different horizons;

(iii) Previous solutions do not reveal the expected investment return over a period of time; and

(iv) Previous solutions do not explicitly link the relationship between the inputs, the decomposition of fair value and expected return.

Previous solutions typically focus on fair value, and seldom compute expected stock return. Expected stock return is a better metric (or at least a supplementary metric) for comparing investment returns. Previous solutions also do not compute the decomposition of stock return into its components, which enables one to understand the source of historical and future stock returns, and also if forecast earnings growth outweigh the costs of purchasing a stock at too high price-earnings ratio.

### BRIEF DESCRIPTION OF THE VIEWS OF THE DRAWINGS

FIG. 1 is a block diagram of a system in accordance with various embodiments.

FIG. 2 is a more detailed block diagram of the system of FIG. 1.

FIG. 3 shows user interface input and output elements generated by the system of FIG. 1, in accordance with various embodiments.

FIG. 4 shows output elements in accordance with various alternative embodiments.

### DETAILED DESCRIPTION OF THE ILLUSTRATED EMBODIMENTS

Attention is directed to U.S. patent application Ser. No. 12/853,541 filed Aug. 10, 2010, invented by the inventor hereof, titled “SYSTEMS AND METHODS FOR ENABLING CONTRIBUTORS TO CREATE AND SHARE FINANCIAL ANALYSIS,” which is incorporated herein by reference. In some embodiments, some or all of the features described herein are integrated into or used in connection with some or all of the features of the system described in the incorporated patent application Ser. No. 12/853,541.

Attention is also directed to U.S. patent application Ser. No. 13/197,337 filed Aug. 3, 2011, invented by the inventor hereof, titled “SYSTEMS AND METHODS FOR ANALYZING A STOCK,” which is incorporated herein by reference. In some embodiments, some or all of the features described herein are integrated into or used in connection with some or all of the features of the system described in the incorporated patent application Ser. No. 13/197,337.

Attention is also directed to U.S. Provisional Patent Application Ser. No. 61/530,938 filed Sep. 3, 2011, invented by the inventor hereof, titled “SYSTEMS AND METHODS FOR ENABLING CONTRIBUTORS TO CREATE AND SHARE FINANCIAL ANALYSIS,” and any corresponding non-provisional patent application filing, which are incorporated herein by reference. In some embodiments, some or all of the features described herein are integrated into or used in connection with some or all of the features of the system described in the incorporated patent application 61/530,938 or some combination of features disclosed in applications 61/530,938; Ser. No. 13,197,337; and Ser. No. 12/853,541.

Various embodiments provide systems and methods that enable a user to calculate (1) the expected return of purchasing a stock or security going forward and (2) the fair value of the stock or security, using only three key inputs.

Various embodiments allow a user to break down expected return and fair value into components to illustrate the key drivers of value and investment return.

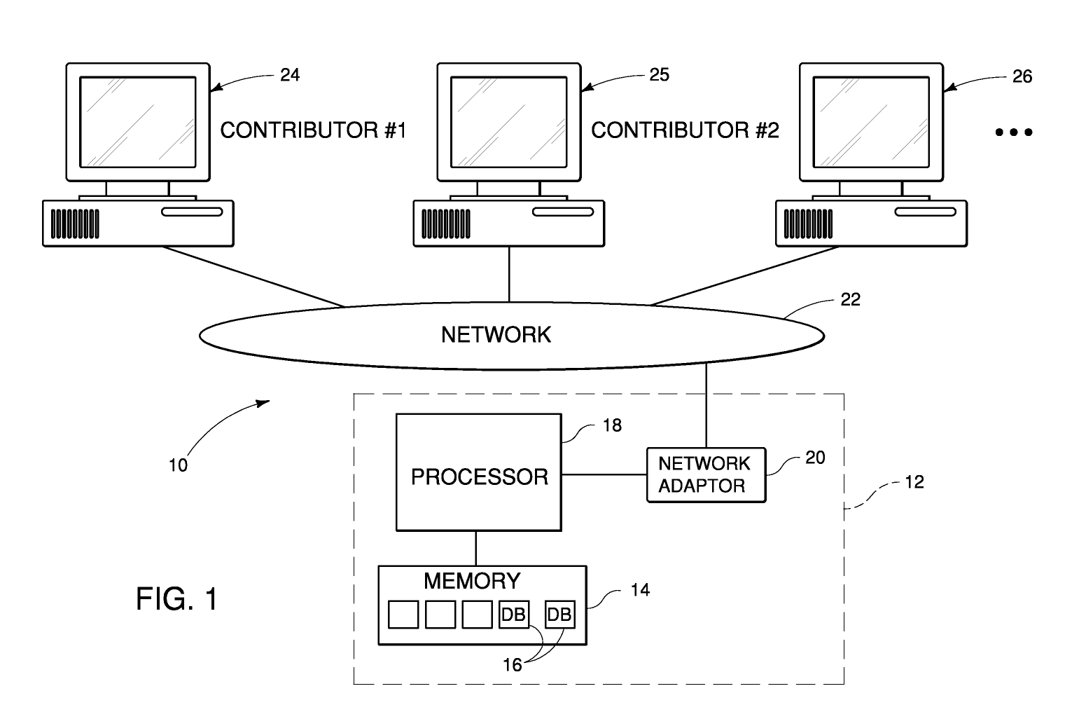

FIG. 1 shows a platform or system 10 in accordance with various embodiments. The system 10 includes a server 12 including a memory device or devices 14 defining one or more databases 16. The database or databases 16 store data. The server 12 also includes one or more processors 18 in communication with the memory 14. The server 12 also includes one or more network adapters 20 enabling communication with a network 22 such as the Internet. Users use terminals or client computers 24, 25, 26, etc. to communicate with the server 12. An application delivered online or offline from the server 12 to the terminals 24, 25, 26 performs the analysis described in this disclosure, in various embodiments.

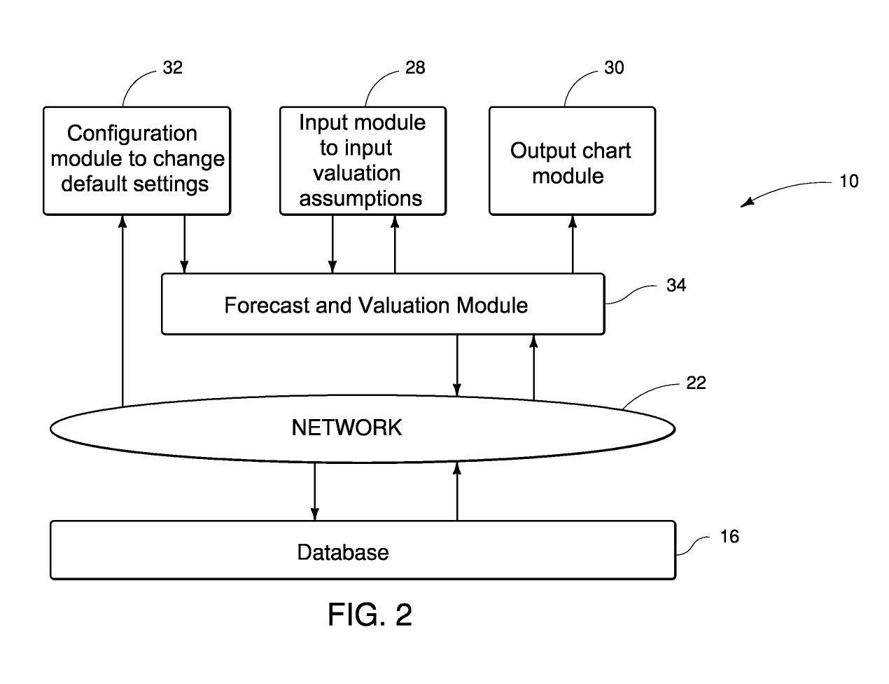

FIG. 2 illustrates that the system 10, in various embodiments comprises various modules.

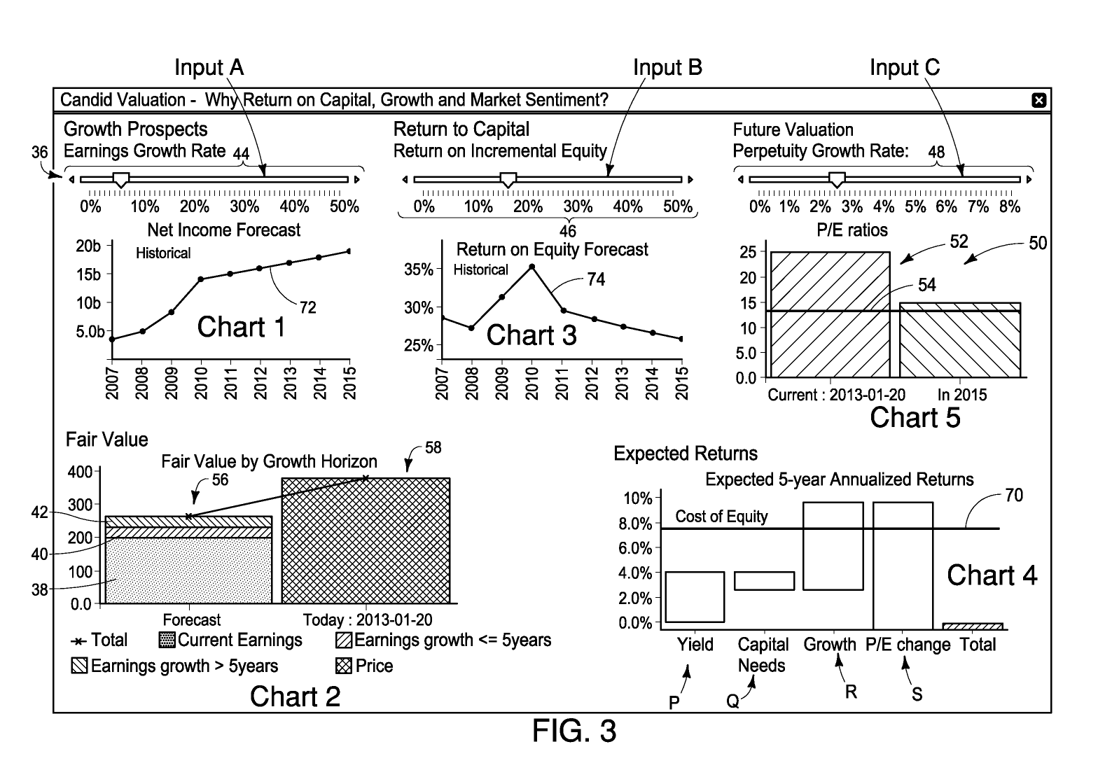

More particularly, in the illustrated embodiment, the system 10 includes an input module 28 that enables a user to input assumptions (e.g., A, B, and C of FIG. 3) for a valuation.

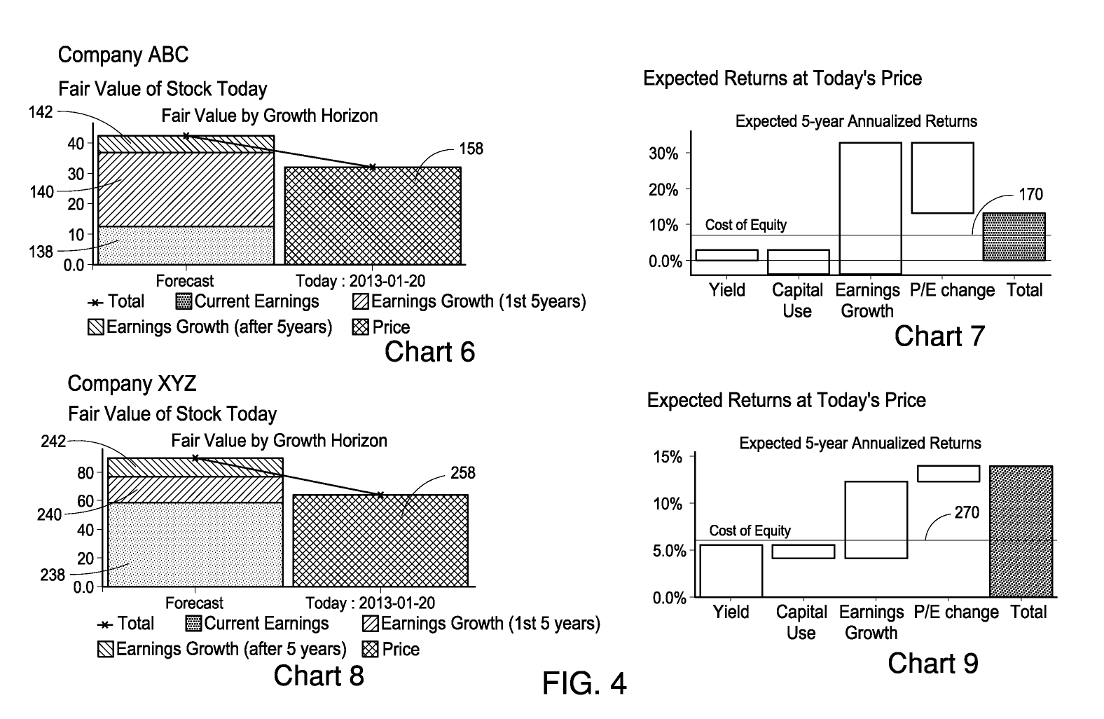

In the illustrated embodiment, the system 10 (see FIG. 2) includes an output module 30 that, in operation, outputs a set of charts (e.g., see charts 1-9 in FIG. 3 and FIG. 4) to illustrate the impact of the input assumptions.

In some embodiments, the system 10 (see FIG. 2) includes a configuration module 32 that enables a user to change default settings, if necessary or desired.

In some embodiments, the system 10 (see FIG. 2) includes a forecast and valuation module 34 that, in operation computes the total shareholder returns between two dates (not shown in FIG. 3 but shown in the above-incorporated patent applications), and, that, in some embodiments, decomposes the return into components. In the illustrated embodiment, the module 34 decomposes the return into, for example: (1) zero growth earnings yield, (2) earnings and yield growth, (3) capital needs for growth, (4) change in price-earnings ratio and (5) timing differences. Other decomposition categories or category names are possible.

In some embodiments, the module 34 outputs the breakdown (decomposition) as a chart. More particularly, in some embodiments, the module 34 outputs the decomposition in the form of a waterfall chart. Other output forms or types of charts are possible.

In some embodiments, the module 34 computes the forecast and fair value and decomposes the fair value into components. In the illustrated embodiment, the fair value is decomposed into (1) value 38 of zero growth; (2) value 40 of near-term earnings growth; and (3) value 42 of long-term earnings growth. Other decomposition categories or category names are possible.

In some embodiments, the module 30 outputs the forecast and fair value in a set of charts (see FIG. 3).

FIG. 3 shows at least a portion of a user interface 36 including user interface components in accordance with various embodiments.

In the illustrated embodiment, the screen comprises three predetermined primary inputs, A, B and C, defined as follows:

| Input | Variable Name | Meaning |
|---|---|---|
| A | EamingsGrowth_Short | Annual earnings growth rate for |
| | | a short-term forecast period |
| B | RONE_Short | Return on Incremental Equity |
| | | (which is the incremental earnings |
| | | per incremental equity) for |
| | | the short-term forecast period |
| C | EamingsGrowth_Long | Annual earnings growth rate after the |
| | | short-term forecast period |

Of course, any desired names can be used for the variables, and specific names are provided for convenience to describe various calculations below. Also, no particular order is implied, and the order of inputs can be rearranged. In some embodiments, exactly three inputs are employed.

In some embodiments, input values are selected by a user using sliders 44, 46 and 48 for interactivity. In other embodiments, input values are input using other methods, such as by a text field, plus and minus buttons, or by dragging a line on a chart. In some embodiments, the symbol for the security will have already been entered on a previous screen (not shown). In other embodiments, the symbol for a security is input on the same screen as the sliders 44, 46, and 48.

In the illustrated embodiment, this valuation module 34 assumes a very simple situation where the growth of a company has two periods: a short-term and a long-term forecast period, each with a constant growth rate and constant return on incremental equity. The number of years in the short-term forecast period can be set to any desired predetermined number, typically between five and ten years. In the illustrated embodiment, the short-term forecast period is set to five years.

In the illustrated embodiment, other settings needed for the valuation are:

| Variable | Meaning | Source for default values |
|---|---|---|
| rₑ | Cost of Equity | Calculated using capital asset |
| | | pricing model (CAPM) formula |
| RONE_Long | Return on Incremental | Typically set to rₑ + 2% |
| | Equity after short-term | |
| | forecast period | |
| Shares | Number of outstanding | Obtained from financial |
| | shares today | database (e.g. Bloomberg) or |
| | | annual reports |
| Price, P | Price of stock today | Obtained from financial |
| | | database (e.g. Bloomberg) |

In some embodiments, a user may change default settings in the configuration module 32, using, for example, a dialog box that allows the user to override the default values. But if the user does not change the default values, a decent valuation will still be performed by using the default values for these settings or variables.

### Forecast and Valuation Module

### I. Computing the Forecast for Short-Term Forecast Period

In the illustrated embodiment, for the short-term forecast period, the forecast is computed using the following equations:

NetIncome[n]=(1+EarningsGrowth_Short)·NetIncome[n−1]

BookEquity[n]=BookEquity[n−1]+(NetIncome[n]−NetIncome[n−1])/RONE_Short

ValueEarningsGrowth[n]=(1+1/rₑ)·(NetIncome[n]−NetIncome[n−1])−(BookEquity[n]−BookEquity[n−1])

ROE[n]=NetIncome[n]·2/(BookEquity[n]+BookEquity[n−1])

for n=1, 2 . . . N
where n=1 refers to the first year of the forecast, and n=N refers to the number of years in the short-term forecast period.

An alternative calculation of ROE is as follows and can be implemented if desired, in alternative embodiments:

ROE[n]=NetIncome[n]/BookEquity[n−1]

In the illustrated embodiment, NetIncome[n] vs time 72 is plotted in Chart 1 of the user interface of FIG. 3. ROE[n] vs time 74 is plotted in Chart 3 of the user interface of FIG. 3.

In the illustrated embodiment, when either Input A or Input B is changed, redrawing of Chart 1 and Chart 3 is initiated immediately, in response to the change and these charts are redrawn immediately or substantially immediately (e.g., as soon as computing power allows) in order to provide immediate, interactive feedback to the user.

### II. Computing Future Value Per Share

In the illustrated embodiment, future value per share is computed as follows:

$$FV = \frac{NetIncome [ N ] \times ( 1 + g ) \times ( 1 - g / RONE\_Long )}{( {r}_{e} - g ) \times Shares}$$

where N is the index of the final year of the short-term forecast.

This method of calculating future value is independent on the free cash flow value in year N, which could be small or even negative if EarningsGrowth_Short is large or even larger than RONE_Short.

In the illustrated embodiment, future price-earnings ratios are calculated as follows:

$$FuturePE = \frac{FV \cdot Shares}{NetIncome [ N ]}$$

Future PE 50 is plotted in Chart 5 of the user interface as illustrated in FIG. 3. In the illustrated embodiment, current Price-Earnings ratio 52 is also shown along with (e.g., adjacent to or in the same screen with) future PE 50. In some embodiments, plotted on the same Chart 5 is also a horizontal line 54 that represents the “Normal PIE” ratio, or the P/E ratio with zero expected future earnings growth. In the illustrated embodiment, the Normal P/E ratio (or Zero Growth P/E ratio) is calculated as follows:

Zero Growth P/E ratio=1/re

### III. Computing Fair Value Per Share

In the illustrated embodiment (see, e.g., FIG. 3, Chart 2), the fair value and decomposition of fair value into its components are computed as follows:

| | |
|---|---|
| D = Value of zero earnings | NetIncome[0]/re/Shares |
| growth per Share | |
| “Current Earnings” | |
| E = Value of earnings growth per share from year 1 to N “Earnings growth <= N years” | $\frac{{\sum }_{i = 1}^{N} ValueEarningsGrowth [ n ]}{{( 1 + {r}_{e} )}^{i} \times Shares}$ |
| F = Value of earnings growth per share after year N “Earnings growth > N years” | $\frac{FV - NetIncome [ N ] / {r}_{e} / Shares}{{( 1 + {r}_{e} )}^{N}}$ |
| G = Total Fair Value per | D + E + F |
| Share “Total” | |

This decomposition is plotted in Chart 2 of the user interface as illustrated in FIG. 3, comparing the fair value 56 against the current price per share 58.

It can be demonstrated that this way of calculating total fair value per share yields the same result as using a traditional discounted free cash flows (DCF) method.

The advantage of this decomposition is that one can break down which portion of the fair value is attributed to more certain current earnings (D) and short-term earnings growth (E), and which portion is attributed to more uncertain long-term earnings growth and market sentiment (F). One of the major philosophies of investing is leaving a margin of safety and discounting the portion that is less certain.

### IV. Computing Expected Return and its Decomposition

The computation of expected return for a given forecast is less common, but in the illustrated embodiment, the breakdown of expected return into its components is advantageously performed (see, e.g., FIG. 3, Chart 4).

In the illustrated embodiment, the total expected return is computed using the internal rate of return (IRR) function for the set of cash flows CF[n] where

CF[0]=−P

CF[n]=FCF[n]/shares=(NetIncome[n]−BookEquity[n]+BookEquity[n−1])/Shares

for n=1, 2, . . . N−1

CF[N]=FCF[N]/Shares+FV=(NetIncome[N]−BookEquity[N]+BookEquity[N−1])/Shares+FV

Where P is today's stock price and FCF is free cash flow.

Internal Rate of Return (IRR) function for a set of cash flows CF(t) is defined as the rate of return r that satisfies the following equation:

$${\sum }_{t}^{ } \frac{CF ( t )}{{( 1 + r )}^{t}} = 0$$

There are many possible alternative implementations to compute IRR.

In the illustrated embodiment, the formulae for expected return and its decomposition into components are as follows:

| Term | Formula |
|---|---|
| P = “Yield” or No Growth Earnings Yield | $\frac{NetIncome [ 0 ]}{BookEquity [ 0 ] \times Shares}$ |
| Q = Capital Needs | $- ( \sqrt[N]{\frac{BookEquity [ N ]}{BookEquity [ 0 ]} - 1} ) \cdot \frac{BookEquity [ 0 ]}{P \times Shares}$ |
| R = “Growth” or Earnings Growth | $( \sqrt[N]{\frac{NetIncome [ N ]}{NetIncome [ 0 ]} - 1} ) \cdot ( 1 + \frac{NetIncome [ 0 ]}{P \times Shares} )$ |
| S = “P/E change” or Change in Price- earnings ratio | $( \sqrt[N]{\frac{FV}{P}} - \sqrt[N]{\frac{NetIncome [ N ]}{NetIncome [ 0 ]}} )$ |
| T = Timing Difference | $IRR [ CF [ n ] ] - \frac{NetIncome [ 0 ]}{BookEquity [ 0 ] \times Shares} + ( \sqrt[N]{\frac{BookEquity [ N ]}{BookEquity [ 0 ]} - 1} ) \cdot \frac{BookEquity [ 0 ]}{P \times Shares} - \\ ( \sqrt[N]{\frac{NetIncome [ N ]}{NetIncome [ 0 ]} - 1} ) \cdot ( 1 + \frac{NetIncome [ 0 ]}{P \times Shares} ) - ( \sqrt[N]{\frac{FV}{P}} - \sqrt[N]{\frac{NetIncome [ N ]}{NetIncome [ 0 ]}} )$ |
| Total | IRR[CF[n]] = P + Q + R + S + T |
| Annualized | |
| Shareholder | |
| Return | |

An advantage of this decomposition is one can understand the expected return in investing the stock and see where it comes from.

In particular, one can see the negative implications of investing a stock when the price-earnings ratio is very high. Price-earnings ratios of stocks are high when investors expect very high growth in earnings. However, if earnings growth is insufficient to justify the expected decline in price-earnings ratio, then the returns from investing in this stock may not be high. Also, earnings per se may not create investment returns if a company must invest lots of capital to grow. The “capital needs” term is a measure of how much capital is required to grow the business.

The total return and its decomposition into its components are plotted on a waterfall chart in Chart 4 of the user interface 36 as illustrated in FIG. 3. In the illustrated embodiment, horizontal line 70 representing cost of equity re is also drawn to show the market expectation of the return in investing in this stock. If a stock valuation results in a return much higher than the cost of equity, it is generally an indication of a good buy. Timing Difference is typically a small number. In typical applications, it is lumped with any one of the other four components, for simplicity.

Analyzing the expected return of a stock allows someone to see if investing in a stock will achieve a given investment return hurdle rate. Calculating the fair value of a stock (by discounted cash flow or our method) does not reveal the expected investment return.

### Relationship Between the Charts

Various embodiments put the three inputs and five charts together on the same page to illustrate the relationships between them. There is a very strong educational benefit to having this set of charts given these relationships.

### Relationship Between “Value of Zero Earnings Growth Per Share” in Chart 2 and “No Growth Earnings Yield” in Chart 4

Value of Zero Earnings Growth is the value of the stock if the company were to continue earning the current level of earnings without needing additional capital. This is often thought as the “base-line” value of the company. This is the portion of the value of the company that is the most certain because it does not require predicting future earnings but verifying how the company earned its current level of earnings and assuming that it can continue at the same level.

For a company that does not grow its income and require additional capital, then the return in investing in this stock is simply its “No Growth Earnings Yield.”

In Chart 2, if “Value of Zero Earnings Growth” is less than the current price, which is generally the case, then “No Growth Earnings Yield” in Chart 4 is less than the cost of equity. When “Value of Zero Earnings Growth” equals current price, then “No Growth Earnings Yield” equals cost of equity.

### Relationship Between “Return on Incremental Equity” Input B and “Return on Equity Forecast” Chart 3

A good analogy of the relationship between Return on Equity and Return on Incremental Equity is that of average speed versus velocity. Whereas Return on Equity takes the ratio of total earnings divided by total equity, Return on Incremental Equity only takes the ratio between the incremental portions, i.e. incremental earnings divided by incremental equity.

By using a simple model that assumes a constant return on incremental equity, a typical situation is modeled when return on equity fades over time to a constant level (“asymptote”), which is the Return on Incremental Equity, in a similar way that after driving at a constant velocity for a long distance, the average speed of the entire journey will get closer and closer to the velocity from its initial value. Hence the Return on Incremental Equity can also be thought of as the long-term return on equity. Studies have shown that return on equity of a company typically fades over time as competitors erode its competitive advantage.

### Relationship Between “Earnings Growth Rate” Input A, “Return on Incremental Equity” Input B and “Fair Value Decomposition” Chart 2

A company creates value above its current earnings if it grows its earnings in a value creating way. By this, we mean that the ValueEarningsGrowth in the following equation used in the short-term forecast period is positive:

ValueEarningsGrowth[n]=(1+1/re)·(NetIncome[n]−NetIncome[n−1])−(BookEquity[n]−BookEquity[n−1])

Note that this is positive only if the Return on Incremental Equity exceeds its expected value, re/(1+re):

(1+1/re)·(NetIncome[n]−NetIncome[n−1])−(BookEquity[n]−BookEquity[n−1])>0

equivalent to

Return on Incremental Equity=(NetIncome[n]−NetIncome[n−1])/(BookEquity[n]−BookEquity[n−1])>re/(1+re)

In other words, a company creates value only if it is investing in projects using its incremental equity that earns net income at a rate that exceeds what it is expected to do.

“Value of earnings growth per share from year 1 to N” in Chart 2 increases as EarningsGrowth increase and as Return on Incremental Equity increases beyond re/(1+re). If Return on Incremental Equity is below re/(1+re), then earnings growth is actually value destroying, and “Value of earnings growth per share from year 1 to N” is actually negative.

In the user interface in FIG. 3, the higher the Input B “Return on Incremental Equity” above re/(1+re), and the higher the Input A “Earnings Growth Rate”, the higher the “Value of Earnings Growth per share from year 1 to N” in Chart 2. There is a very strong educational value in this.

Note that this is more powerful than the traditional decomposition of value by free cash flow horizons because free cash flow horizons do not reveal whether the incremental cash flow invested in projects create value or not.

Relationship between “Earnings Growth Rate” Input A, “Return on Incremental Equity” Input B and “Expected Returns” Chart 4

A similar relationship exists between Input A, Input B and Chart 4. The amount that “Earnings Growth” contributes to investment return in Chart 4 is directly proportional to EarningsGrowth_Short. The amount that “Capital Needs” contribute to investment return in Chart 4 is inversely proportional to RONE_Short. Companies with high Return on Incremental Equity require very little capital to grow earnings and can generate lots of investment returns.

### Relationship Between “Perpetuity Growth Rate” Input C, “P/E Ratios” Chart 4, and “Fair Value” Chart 2

Future P/E ratio, which is driven by EarningsGrowth_Long, drive fair value in Chart 2 as follows:

The higher the “P/E in Year N” above the “Normal P/E ratio”, the larger the “Value Creation after year N” in Chart 2. When “P/E in Year N” equals “Normal P/E ratio”, “Value Creation after year N” equals 0.

### Relationship Between “Perpetuity Growth Rate” Input C, “P/E Ratios” Chart 4, and “Expected Returns” Chart 4

Future P/E ratio, which is driven by EarningsGrowth_Long, drive expected returns in Chart 4 as follows:

The higher the “P/E in Year N” above (below) the “Current P/E ratio”, the more positive (negative) the impact of “Change in P/E” in Chart 4. When “P/E in Year N” equals “Current P/E”, impact of “Change in P/E” equals 0.

### Relationship Between Fair Value in Chart 2 and Expected Returns in Chart 4

When Fair Value exceeds the Current Share Price, then Expected Returns is greater than Cost of Equity. The reverse is true.

FIG. 4 shows various alternative embodiments. In some embodiments, the Charts 8 and 9 of FIG. 4 are also shown on the same user interface 36 with Charts 1-5. In other embodiments, the Charts 6-9 of FIG. 4 are shown in a separate user interface or separate screen. In some embodiments, Charts 6 and 7 are provided in which the outputs of the valuation are compared to understand the risk versus reward of investing in one stock versus another.

For example, in the illustrated embodiment, Chart 6 illustrates value 138 of zero growth; value 140 of near-term earnings growth; value 142 of long-term earnings growth; and current price per share 158 for one company “ABC” while Chart 8 illustrates value 238 of zero growth; value 240 of near-term earnings growth; value 242 of long-term earnings growth; and current price per share 258 for another company “XYZ”. The total return and its decomposition into its components of Company ABC are plotted on chart in Chart 7, while total return and decomposition into components of company XYZ are shown in Chart 9. Horizontal lines 170 in Chart 7 and 270 in Chart 9 representing cost of equity are also drawn to show the market expectation of the return in investing in the respective stocks.

Potential upside is computed as follows:

U=% upside=(D/Current Price−1)×100

Stocks that are currently more undervalued will have higher potential upside.

One measure of risk measures the value of zero earnings growth per share and value of earnings growth per share from year 1 to N as a percentage of current share price. Companies whose value derive mostly from near term earnings growth are less risky than those that depend from earnings growth in the future.

R=value from zero growth and earnings growth from year 1 to N %

current price=((A+B)/Current Price−1)×100

By presenting the two valuations side by side in Charts 6 and 7, and comparing the two metrics for company 1 and company 2:

| Case | Meaning |
|---|---|
| U1 > U2, R1 > R2 | Company 1 has more upside and lower risk |
| | than Company 2 |
| U1 > U2, R1 < R2 | Company 1 has more upside but higher risk |
| | than Company 2 |
| U1 < U2, R1 < R2 | Company 1 has lower upside and higher |
| | risk than Company 2 |
| U1 < U2, R1 > R2 | Company 1 has lower upside but lower risk |
| | than Company 2 |

By presenting the charts side by side as in FIG. 4, one can also be very explicit about the assumptions that go into the valuation. For instance, Company 1 may have a higher upside than Company 2, but it assumes a higher earnings growth rate, which will be shown by a taller earnings growth in the charts on the right hand side. This may mean that Company 1 has a higher risk compared to Company 2.

The implementation of the front-end user interface of some embodiments is done in Javascript running on a browser, with chart libraries from Dojo, a Javascript framework. An alternative implementation is done in an iOS operating system running on an iPad, iPhone, or other iOS device. By using callback functions for the horizontal sliders for the inputs A, B, and C, the forecasts are recalculated automatically when the inputs change and the charts are updated immediately, thereby providing the interactivity desired. In some embodiments, the back-end server is implemented using php running on a MySQL database server to feed the default settings needed for the valuation.

Other embodiments are possible. The user interface can run on a web-browser (such as Internet Explorer, Firefox, Safari, etc.) using Javascript, on a user terminal or computer 24, 25, or 26. In these embodiments, the terminal 24, 25, or 26 interacts with server 12. In other embodiments, a stand-alone version is downloaded from the server 12 or installed from a computer readable storage medium. In the stand-alone version, the user interface is implemented in a computer language such as C++ and compiled to an executable or in a computer language such as visual basic.

In other embodiments, more calculations are performed on the terminal application, but this impacts the speed of the application.

While some embodiments disclosed herein are implemented in software, alternative embodiments comprise hardware, such as hardware including digital logic circuitry. Still other embodiments are implemented in a combination of software and digital logic circuitry.

Various embodiments comprise a computer-usable or computer-readable medium, such as a hard drive, solid state memory, flash drive, floppy disk, CD (read-only or rewritable), DVD (read-only or rewritable), tape, optical disk, floptical disk, RAM, ROM (or any other tangible medium capable of storing program code) bearing computer program code which, when executed by a computer or processor, or distributed processing system, performs some or all of the functions described above.

Some embodiments provide a carrier wave or propagation signal, medium, or device embodying such computer program code for transfer of such code over a network or from one device to another.

In compliance with the patent statutes, the subject matter disclosed herein has been described in language more or less specific as to structural and methodical features. The claims description above only discloses example embodiments. Alternatives are contemplated.

I/We claim:

1. A system for analyzing a security, the system comprising:
a processor;
an input module configured to cause a graphical user interface to be rendered on a user's client device, the interface including a screen presenting a predetermined limited number of inputs relating to characteristics affecting valuation of a security, the predetermined number being not more than four;
a forecast valuation module configured to compute, using the processor acting on the inputs, fair price and expected return for the security; and
an output module configured to cause the user's client device to display fair price and expected return for the security; whereby in presenting only a limited number of inputs, a user is able to focus on more important inputs and is not overwhelmed with too many inputs that can be varied.

2. A system in accordance with claim 1 and wherein the predetermined number is no more than three.

3. A system in accordance with claim 1 and wherein the predetermined inputs include an input for expected short term earnings growth rate, an input for expected return on incremental equity, and an input for expected long term earnings growth rate.

4. A system in accordance with claim 1 and wherein the forecast valuation model is configured to forecast net income for various times in the future, to forecast return on equity, for various times in the future, to forecast price to earnings ratio, to forecast fair value components including at least current earnings, short term earnings growth, and long term earnings growth, and to forecast expected return components including at least yield, capital needs, growth, and price to earnings ratio change.

5. A system in accordance with claim 4 and wherein the output module is configured to cause the user's client device to display forecast net income for the security for various times, forecast return on equity for various times, both current and projected price to earnings ratios, fair value, broken down into components, and to display expected returns, broken down into components.

6. A system in accordance with claim 5 and wherein the fair value components to be displayed include current earnings, short term earnings growth, and long term earnings growth.

7. A system in accordance with claim 5 and wherein the expected returns components to be displayed include yield, capital needs, growth, and price to earnings ratio change.

8. A system in accordance with claim 1 and wherein the cost of the security is not input by the user.

9. A system for analyzing a security, the system comprising:
a user's client device including a processor; and
a server in selective communication with the user's client device via a network;
at least one of the server and the user's client device defining:
an input module the server being configured to cause a graphical user interface to be rendered on a user's client device, the interface including a screen presenting a predetermined limited number of user actuable graphic items which a user can respectively manipulate, using the user's client device, to define inputs relating to characteristics affecting valuation of a security, the predetermined number being not more than three, the inputs excluding cost of the security, the input module being configured to obtain a cost of the security from a database remote to the system, via the network;
a forecast valuation module configured to forecast net income for various times in the future, to forecast return on equity, for various times in the future, to forecast price to earnings ratio for a time in the future, fair value, and to forecast expected returns for the security; and
an output module configured to cause the user's client device to display net income for various times in the future, return on equity, for various times in the future, price to earnings ratio for a time in the future, fair value, and expected returns for the security.

10. A system in accordance with claim 9 and wherein the output module is configured to cause the user's client device to display both historical and forecast net income for the security for various times, both historical and forecast return on equity for various times, both current and projected price to earnings ratios, fair value, broken down into components, and to display expected returns, broken down into components in a waterfall chart.

11. A system in accordance with claim 10 and wherein the fair value components to be displayed include current earnings, short term earnings growth, and long term earnings growth.

12. A system in accordance with claim 10 and wherein the expected returns components to be displayed include yield, capital needs, growth, and price to earnings ratio change.

13. A system in accordance with claim 10 and wherein the forecast valuation module is configured to forecast, for a second security, net income for various times in the future, forecast return on equity, for various times in the future, forecast price to earnings ratio for a time in the future, fair value; and to forecast expected returns; and wherein the output module is configured to cause the user's client device to display, for the second security, net income for various times in the future, return on equity, for various times in the future, price to earnings ratio for a time in the future, fair value, and expected returns for the second security, proximate the net income, return on equity, and price to earnings ratio for the first security, for easy comparison of the first security to the second security.

14. A method of analyzing a security, the method comprising:
causing a graphical user interface to be rendered on a user's client device, the interface including no more than three sliders which a user can adjust to adjust the values of respective inputs affecting value of a security, including an input for expected short term earnings growth rate, an input for expected return on incremental equity, and an input for expected long term earnings growth rate;
forecasting, using a processor, net income for various times in the future, return on equity, for various times in the future, price to earnings ratio, fair value components including at least current earnings, short term earnings growth, and long term earnings growth, and expected return components including at least yield, capital needs, growth, and price to earnings ratio change;
causing the display of a first chart, on the user's client device, showing a graph of both historical and forecast net income for the security versus time;
causing the display of a second chart, on the user's client device, showing a graph of both historical and forecast return on equity for the security versus time;
causing the display of a third chart, on the user's client device, showing both current and projected price to earnings ratios for the security;
causing the display of a fourth chart, on the user's client device, showing fair value for the security, broken down into multiple separate components for current earnings, short term earnings growth, and long term earnings growth; and
causing the display of a fifth chart, on the user's client device, showing expected returns for the security, broken down into multiple separate components for yield, capital needs, growth, and price to earnings ratio change.

15. A method in accordance with claim 14 wherein the fifth chart is a waterfall chart.

16. A method in accordance with claim 14 further comprising obtaining a cost of the security from a database without requiring a user of the client device to input the cost of the security.

17. A method in accordance with claim 14 and further comprising redrawing the charts in response to a user moving at least one of the sliders.

18. A method in accordance with claim 14 and further comprising causing the display of a fifth chart, on the user's client device, showing fair value for a second security, broken down into multiple separate components for current earnings, short term earnings growth, and long term earnings growth; and
causing the display of a sixth chart, on the user's client device, showing expected returns for the second security, broken down into multiple separate components for yield, capital needs, growth, and price to earnings ratio change

19. A method in accordance with claim 14 and further comprising obtaining data from a database for use in rendering the historical portions of the first and second charts.

20. A memory bearing computer program code which, when executed in a computer, causes the computer to perform the method of claim 14.
